(19) United States
(12) Patent Application Publication
(10) Pub. No.: US 2015/0136237 A1
(43) Pub. Date: May 21, 2015

(54) CONTAINER AND LIQUID COLLECTION METHODS

(71) Applicant: Michael Richard PLUTA, Huntington Beach, CA (US)

(72) Inventor: Michael Richard PLUTA, Huntington Beach, CA (US)

(21) Appl. No.: 14/252,326

(22) Filed: Apr. 14, 2014

Related U.S. Application Data
(60) Provisional application No. 61/906,503, filed on Nov. 20, 2013.

(51) Int. Cl. F17D 1/08

(52) U.S. Cl. CPC F17D 1/08
USPC 137/15.01; 137/313

(57) ABSTRACT

A method for permitting the removal of a canister of fluid from a source of fluid is provided that includes loosening a canister of fluid from a source of fluid to expose a connection between the two, providing a form fitting non-permeable bag for collecting where the bag includes means for securing the top of the bag to prevent collected fluid from spilling out of the bag, wrapping the top of the bag of around the canister to bring the top of the bag proximate to the connection, disconnecting the canister from the connection while the bag is still positioned around the canister, and closing the securing means to close the top of the bag to seal off the canister within the bag.

### RELATED APPLICATION

The present application claims priority from Provisional Application Ser. No. 61/906,503 filed Nov. 20, 2013, the entire contents of which are incorporated herein in its entirety by reference

### BACKGROUND

The present invention relates to methods for collecting containers and liquids so as to minimize spillage of such liquids when removing containers, and more specifically, in one example, to a method for removing an oil filter without spilling oil onto the ground or within the engine compartment. Changing oil filters ordinarily involve some spillage of oil. Often, those trying to change the filters employ some collection pan or the like to collect the oil. But that oil must then be transferred to a disposal system of one type or another. The methods of the present invention eliminate the first step by collecting the oil filter and any spillage of oil directly into a disposal system.

### SUMMARY

In embodiments of the present invention, a system for permitting the removal of a canister of fluid from a source of fluid while minimizing leakage of fluid is provided. In some embodiments, the system comprises a form fitting non-permeable bag for collecting fluid therewithin, the bag having an opening at a first end thereof, the system further comprising a means for securing the top of the bag to prevent collected fluid from spilling out of the bag uncontrollably. In some cases, the securing means comprises an elastic band that can be easily expanded and contracted as necessary. In other embodiments, the securing means may comprise a sleeve proximate the top of the bag through which a tie may be place, while leaving both ends of the tie exposed, to draw the top of the bag closed and for both ends to be tied off to secure the bag in a closed position.

The present invention also includes methods of permitting the removal of a canister of fluid from a source of fluid while minimizing leakage of fluid. In some embodiments, the method comprises loosening a canister of fluid from a source of fluid, but leaving the canister still connected to the source, thus exposing a connection between the canister and the source; providing a form fitting non-permeable bag for collecting fluid therewithin, the bag having an opening at a first end thereof, the system further comprising a means for securing the top of the bag to prevent collected fluid from spilling out of the bag uncontrollably; wrapping the top of the bag of around the canister to bring the top of the bag proximate to the connection between the canister and the source; disconnecting the canister from the connection thereby detaching the canister from the source while the bag is still positioned around the canister, and closing the securing means to close the top of the bag to seal off the canister within the bag.

### BRIEF DESCRIPTION OF THE FIGURES

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is a perspective view of a container such as an oil filter connected to an oil distribution system to which embodiments of the present invention may apply;

FIG. 2 is a side view of one embodiment usable in the methods of the present invention;

FIGS. 3-7 are side views of Steps A through E of one method of the present invention;

FIG. 8 is a perspective view of a container connected to a fluid system to which embodiments of the present invention may apply;

FIG. 9 is a side view of one embodiment usable in the methods of the present invention;

FIGS. 10-14 are side views of Steps A through E of an alternative method of the present invention.

### DETAILED DESCRIPTION OF CERTAIN EMBODIMENTS

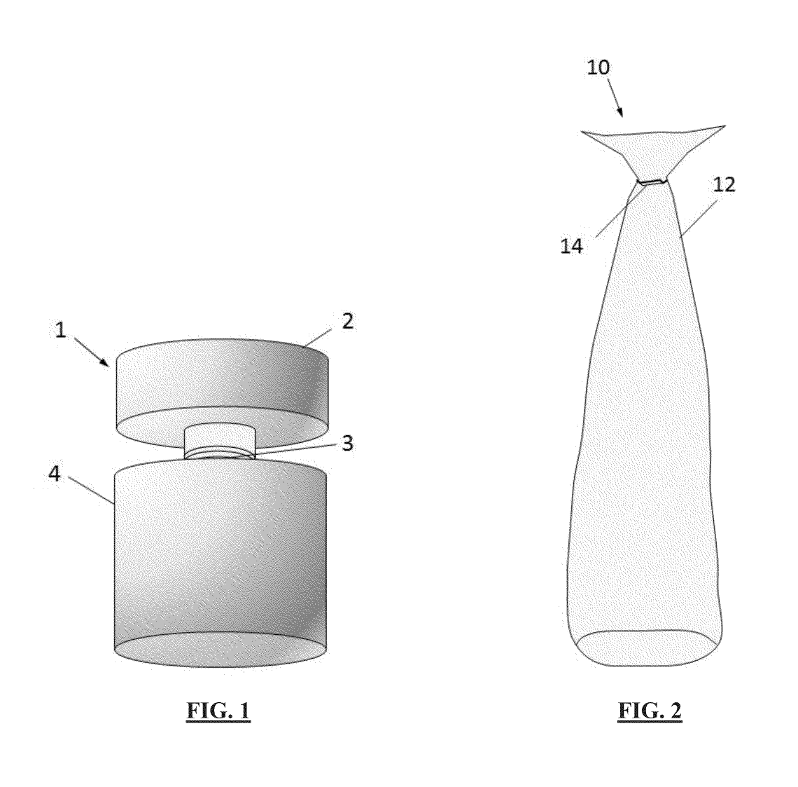

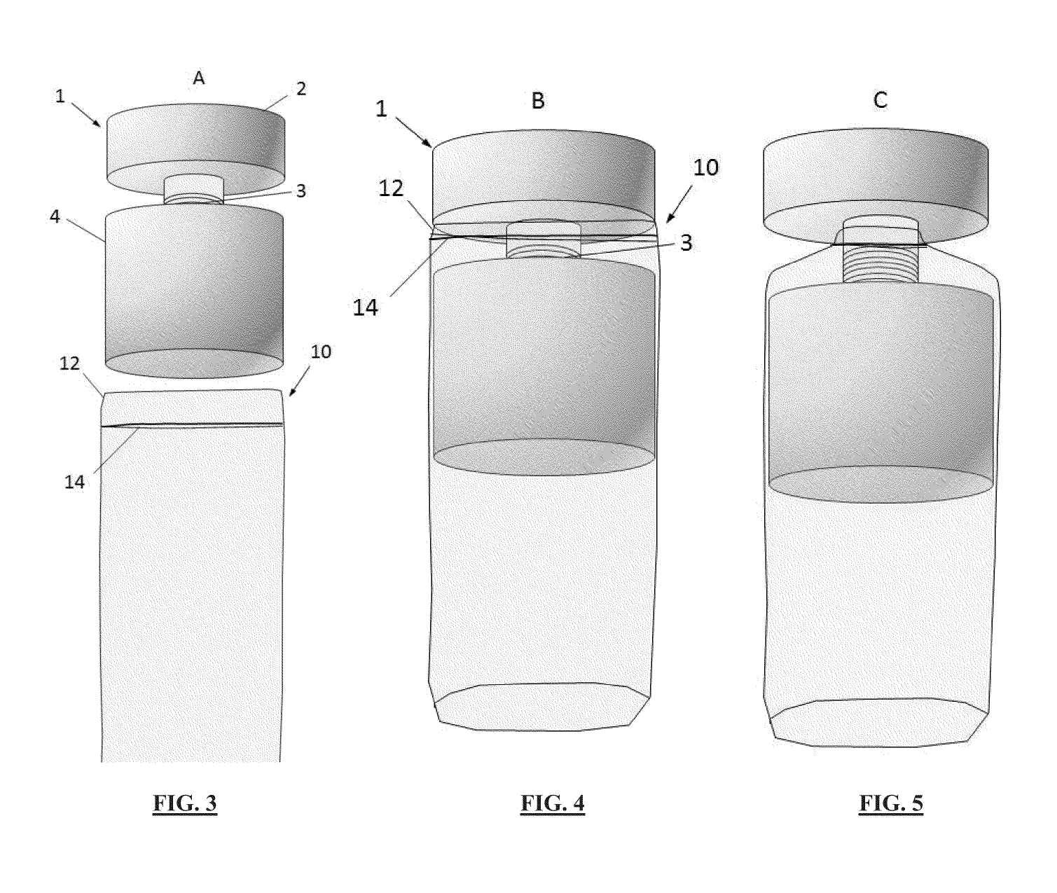

By way of example, and referring to FIG. 1, one application of the methods of the present invention may be to an oil distribution system 1 within an automotive vehicle, where the system 1 includes a distribution housing 2, an oil transfer pipe connected at connection point 3 to an oil filter 4. Referring to FIG. 2, one embodiment of a collection system 10 useful for the methods of the present invention comprises a resilient water-tight bag 12 having an elastic band 14 proximate the opening at the top of the bag to seal the bag essentially closed when the band is in its normally contracted state.

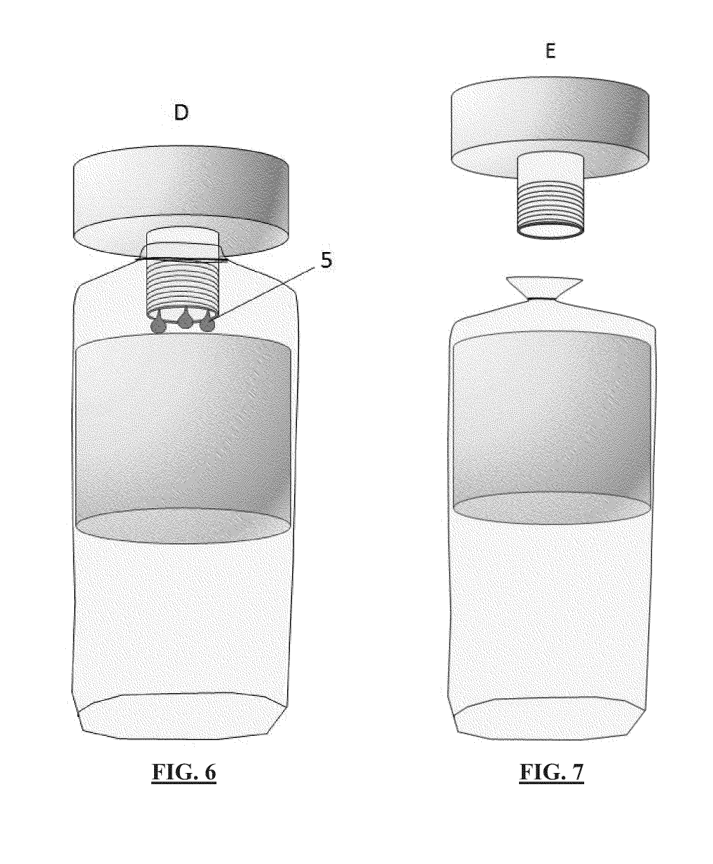

Referring to FIGS. 3 through 7, Steps A through E may be described. In one example embodiment, the collection system 10 is brought to the oil filter (A) and placed over the oil filter and the oil transfer pipe above the connection point 3 by stretching the elastic band 14 (B). The band is then released to substantially enclose the transfer pipe above the connection point while the oil filter 4 is then removed (e.g., unscrewed from the oil transfer pipe) (C). The oil filter 4 is continued to be removed, along with any residual oil 5 in the oil transfer pipe and/or oil distribution system 1 and permitted to be enclosed within the bag 12 (D). Once the filter is completely removed and all excess oil 5 has stopped dripping, the bag 12 may be removed from the oil distribution system 1 and the elastic band 14 may be permitted to contract to substantially seal the contents therein (E), permitting immediate disposal of the contents.

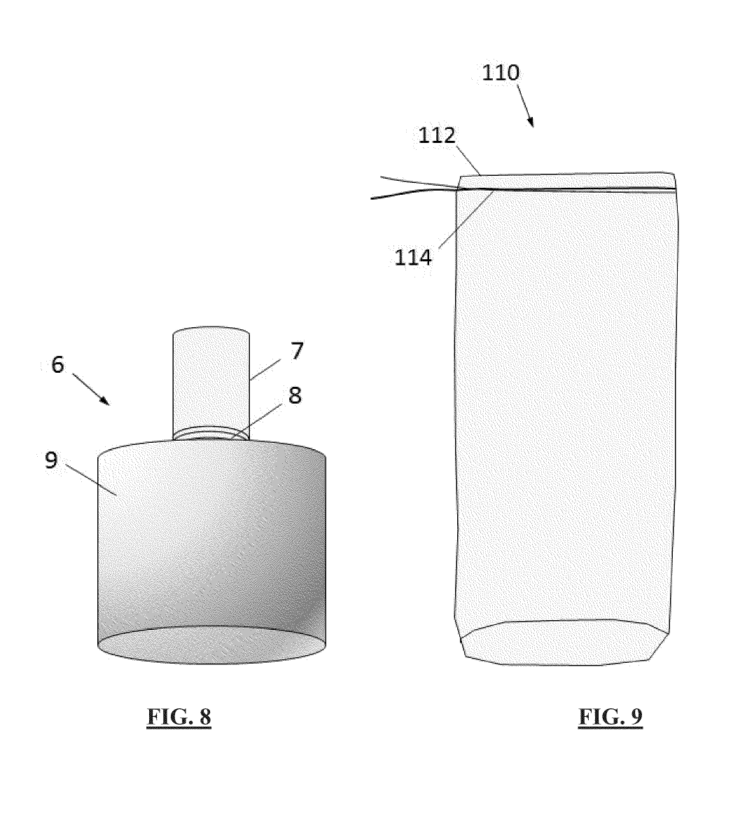

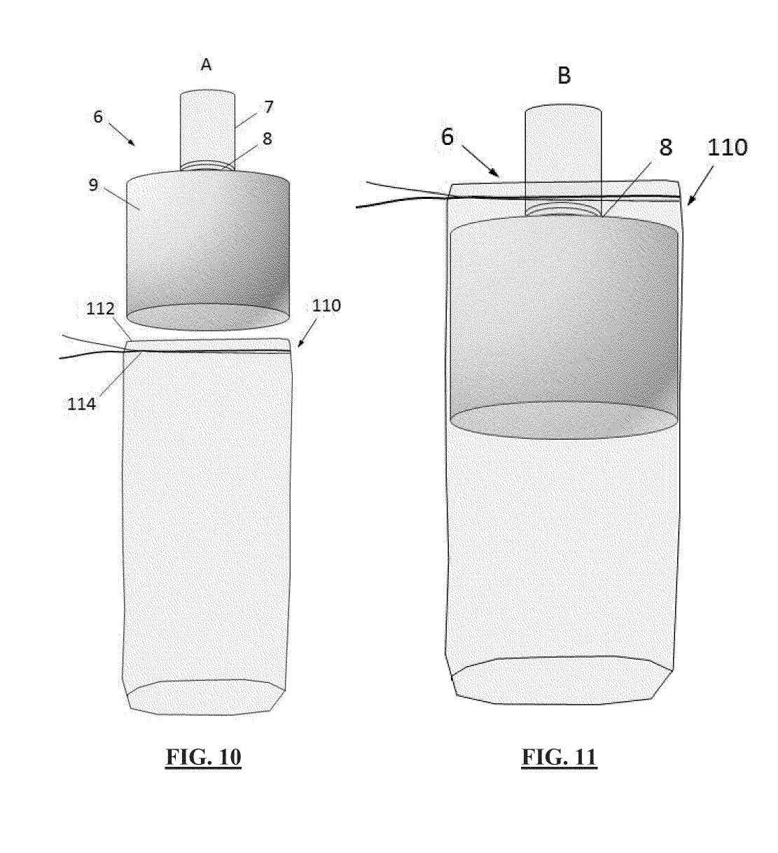

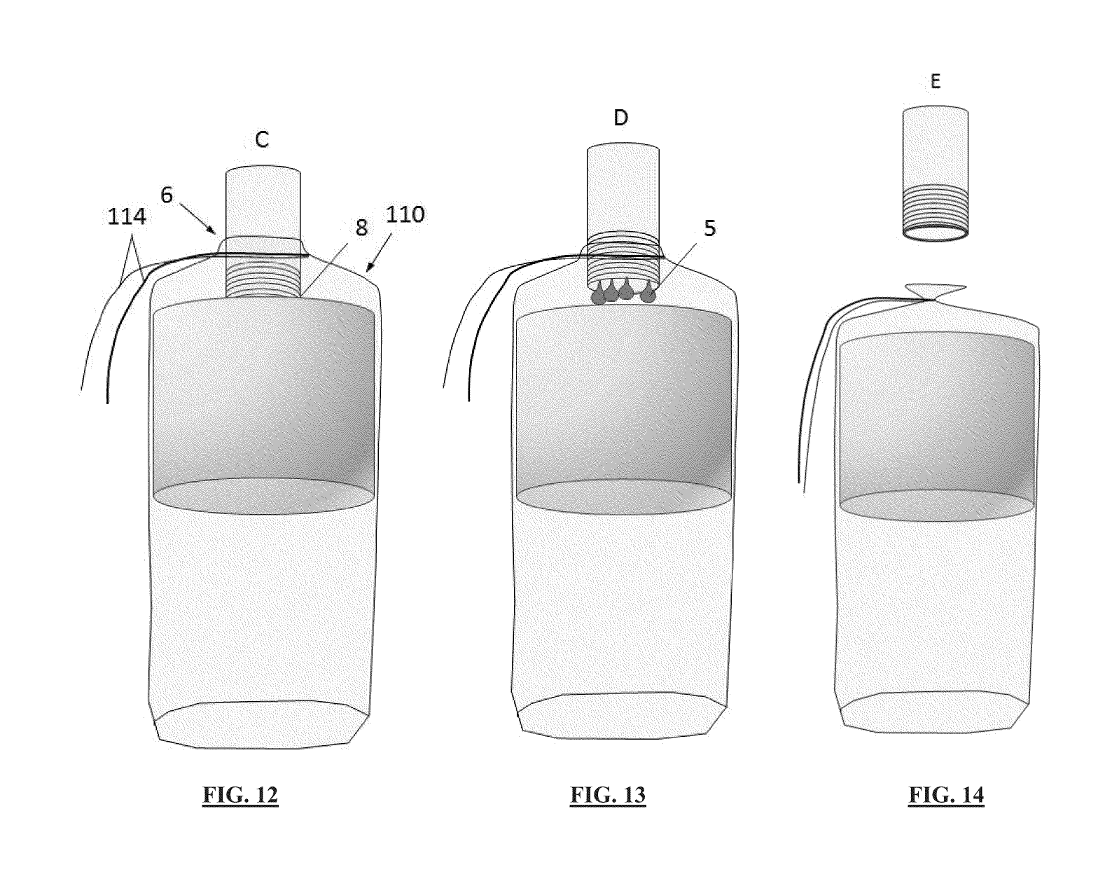

Referring to FIGS. 8 and 9, a liquid distribution system 6 has a liquid transfer pipe 7 connected at a connection 8 to a reservoir 9, where it is desired to remove the reservoir 9 and liquid contents into collection system 110 comprising a resilient water-tight bag 112 and a purse-string 114 proximate the opening at the top of the bag. Unlike the elastic band, which is naturally contracted into a substantially sealed position, the purse-string allows the user more control over the size of the bag opening. Referring to FIGS. 10-14, it may be appreciated that Steps A through E may be employed, similarly to Steps A through E of FIGS. 3 through 7 described above.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for permitting the removal of a canister of fluid from a source of fluid while minimizing leakage of fluid, the system comprising a form fitting non-permeable bag for collecting fluid therewithin, the bag having an opening at a first end thereof, the system further comprising a means for securing the top of the bag to prevent collected fluid from spilling out of the bag uncontrollably.

2. The system of claim 1, wherein the securing means comprises an elastic band.

3. The system of claim 1, wherein the securing means comprises a sleeve proximate the top of the bag through which a tie may be place, while leaving both ends of the tie exposed, to draw the top of the bag closed and for both ends to be tied off to secure the bag in a closed position.

4. A method permitting the removal of a canister of fluid from a source of fluid while minimizing leakage of fluid, the method comprising:
loosening a canister of fluid from a source of fluid, but leaving the canister still connected to the source, thus exposing a connection between the canister and the source;
providing a form fitting non-permeable bag for collecting fluid therewithin, the bag having an opening at a first end thereof, the system further comprising a means for securing the top of the bag to prevent collected fluid from spilling out of the bag uncontrollably;
wrapping the top of the bag of around the canister to bring the top of the bag proximate to the connection between the canister and the source;
disconnecting the canister from the connection thereby detaching the canister from the source while the bag is still positioned around the canister, and
closing the securing means to close the top of the bag to seal off the canister within the bag.
